(19) United States
(12) Patent Application Publication
(10) Pub. No.: US 2011/0034139 A1
(43) Pub. Date: Feb. 10, 2011

(54) System and Method of Automatic Tuning Adjustment for Portable Radio Frequency Receivers

(75) Inventors: Peiqi Xuan, Saratoga, CA (US); Yifeng Zhang, San Jose, CA (US)

Correspondence Address: Blairtech Solution LLC, 1039 Merritt Terrace, Sunnyvale, CA, 94086, US

(73) Assignee: QUINTIC HOLDINGS, Santa Clara, CA (US)

(21) Appl. No.: 12/535,599

(22) Filed: Aug. 4, 2009

(51) Int. Cl. H04B 1/18

(52) U.S. Cl. 455/179.1

(57) ABSTRACT

Systems and method for automatic adjustment of tunable filter for portable radio frequency receivers. The effective antenna impedance for a portable radio frequency receiver is often affected by human body. The front end tunable filter may become off tuned due to human body effect. The system relies on radio frequency signals received from an antenna interface and utilizes receive path circuitry to derive signal parameters about the received signal. Tuning control circuitry is used to provide control signals based on the signal parameters to adjust the tunable filter to achieve the best receiver performance. A method is disclosed for automatic adjustment of the tunable filter. The method comprises steps of receiving radio frequency signals, filtering the received radio frequency, processing the filtered signal to obtain digitized signals, deriving signal parameters based on the digitized signal; providing control signals to adjust the tunable filter, and repeating the steps until a desired result is achieved with respect to the signal parameters.

### FIELD OF THE INVENTION

The present invention generally relates to radio frequency receivers and particularly to automatic tuning adjustment of radio frequency receivers using a tunable filter.

### BACKGROUND

Radio frequency receivers have been widely used in various electronic products such as AM and FM radios, television sets, and GPS (global positioning system) navigation devices. Typically there are multiple channels within the allocated spectrum. In order to receive the signal in a desired channel, the radio frequency input signal is usually mixed with a single-frequency signal generated by a local oscillator (LO) to translate the incoming radio frequency signal to a lower-frequency signal suitable for further processing using cost effect components and/or for superior performance. The frequency translated signal may be a baseband signal, low-IF (intermediate frequency) or IF signal. The low frequency characteristic of the frequency translated signal makes itself ideal for digital signal processing at lower clock speed to conserve power consumption. In addition, the use of digital signal processing technique provides high flexibility for processing the underlying signal.

Radio frequency receiver often uses a tunable filter to filter out unwanted radio frequency signals. The tunable filter usually is located close to the antenna side so that the unwanted signal is filtered out at early stage of the signal receiving path to prevent possible interference. After the incoming radio frequency signal is mixed with a selected LO signal to generate a desired frequency-translated signal, a bandpass or a low pass filter is applied to filter out possible interfering signals. Though the bandpass or low pass filtering to the frequency-translated signal at the mixer output will allow intended signal to pass the remaining receiving chain, there is a risk that an unwanted signal having a frequency image of the desired signal will enter the receiver system and cause interference if a front-end tunable filter is not used. The front-end tunable filter is an effective way to filter out the unwanted signals to alleviate interference. The tunable filter typically has a bell-shaped frequency response and an adjustable center frequency. If the antenna impedance is fixed and known, it is possible to determine the correct value of the tunable filter to obtain the best tuning for a given desired channel. This may be the case for a table top radio or a living room television set. However, for portable devices such as cellphones and PMP (portable media player) with built-in FM receiver or mobile TV receiver, the effective antenna impedance is very unpredictable because human body can contribute significantly to the overall antenna impedance. Therefore it is desirable to provide a method and system that can automatically adjust the tunable filter to tune to a desired channel in a dynamic portable device environment.

In U.S. Pat. No. 7,127,217, entitled “On-Chip Calibration Signal Generation for Tunable Filters for RF Communications and Associated Methods”, methods and systems were disclosed to provide automatic tuning. The invention of U.S. Pat. No. 7,127,217 includes an on-chip calibration signal generation circuitry and an associated calibration mode. In the calibration mode, the on-chip calibration signal generation circuitry will provide a calibration signal for adjustment of the tunable filter. In the calibration mode, the normal radio frequency receiving will not be properly performed because the desired normal radio frequency signal is overshadowed by the calibration signal. There is another drawback of the invention disclosed in U.S. Pat. No, 7,127,217. Though part of the calibration signal generation circuitry may be shared with existing receiver circuits, there will be still some additional circuits required based on the approach.

In light of the foregoing discussions, therefore it is desirable to provide methods and systems for automatic adjustment of tunable filter which does not interfere with normal radio frequency reception. Furthermore, it is desirable to provide a system that requires no additional circuits or only requires a very minimum hardware increase.

### BRIEF SUMMARY OF THE INVENTION

The present invention discloses methods and systems for automatic adjustment of tunable filter for portable radio frequency receivers including the AM and FM audio broadcast bands, and television broadcast bands. Unlike the approach disclosed in U.S. Pat. No. 7,127,217 where a calibration signal is generated on-chip, the present invention relies on the radio frequency signal received from an antenna to derive needed control signal. Therefore, the receiver can be always in the receive mode without interrupt of service during the calibration. The present invention derives signal parameters based on the radio frequency signal received from the antenna, and utilizes the signal parameters to form control signals used to adjust the tunable filter to obtain desired result.

In one embodiment, the present invention discloses a method for automatic adjusting a tunable filter. The method comprises receiving a radio frequency signal from an antenna port, filtering the radio frequency signal for a desired channel using a tunable filter having an adjustable center frequency and coupled to receive control signals for adjusting the center frequency, processing the radio frequency signal filtered by the tunable filter to obtain a digitized signal using receive path circuitry, deriving signal parameters based on the digitized signal, adjusting the control signals according to the signal parameter, and repeating the filtering, processing, deriving, and adjusting steps until a desired result is achieved with respect to the signal parameters.

In another embodiment of the present invention, a system is disclosed for a radio frequency receiver using a tunable filter. The system comprises an antenna interface coupled to receive a radio frequency signal having a plurality of channels. A tunable filter is coupled to the antenna interface and is configured to filter the radio frequency signal for a desired channel, wherein the tunable filter has a center frequency adjustable to cover a spectrum for the plurality of channels and the tunable filter is coupled with control signals for adjusting the center frequency. Receive path circuitry is used and configured to receive and process the radio frequency signal filtered by the tunable filter to obtain a digitized signal. The receive path circuitry further derives signal parameters based on the digitized signal and provides the signal parameters to tuning control circuitry for adjusting the tunable filter.

In yet another embodiment, the tunable filter comprises an inductor and tunable capacitor circuitry. The tunable filter may be in part on the same integrated circuit as the receive path. In a further embodiment, the signal parameters derived for control signals include received signal strength indicator (RSSI). In another embodiment, the tuning control circuitry is on the same integrated circuit as the receive path circuitry.

### BRIEF DESCRIPTION OF THE DRAWINGS

FIG. 1 shows a system block diagram of a radio frequency receiver incorporating automatic adjustment for a tunable filter.

FIG. 2 shows an alternative system block diagram of a radio frequency receiver incorporating automatic adjustment for a tunable filter.

FIG. 3 shows a profile of received signal strength indicator measured in a stationary environment.

FIG. 4 shows a flow chart of automatic adjustment for a tunable filter.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

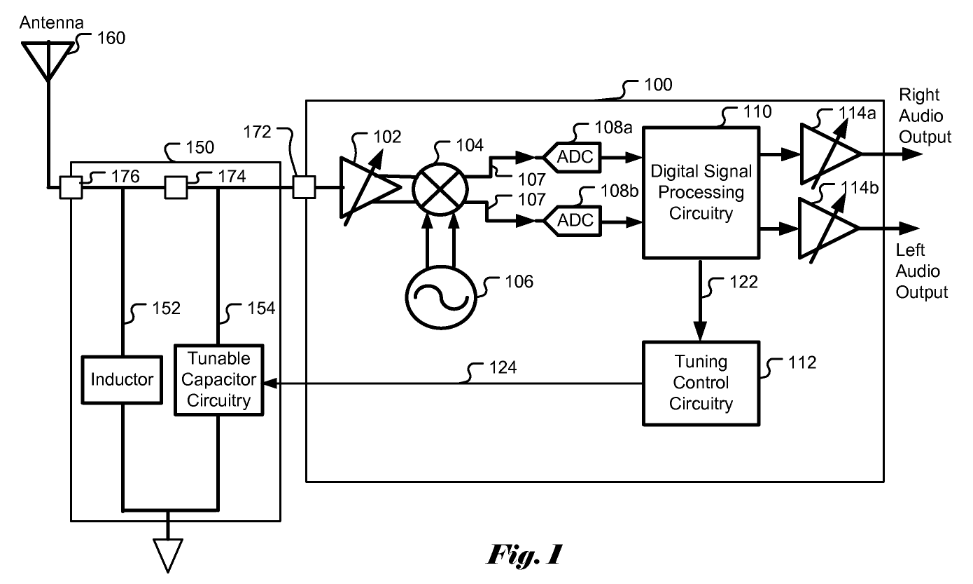

Embodiments of the present invention are discussed herein with reference to FIG. 1 to 4. However, those skilled in the art will readily appreciate that the detailed description given herein with respect to these figures is for explanatory purposes as the invention extends beyond these limited embodiments.

Although the present invention has been described in terms of specific embodiments it is anticipated that alterations and modifications thereof will no doubt become apparent to those skilled in the art. It is therefore intended that the following claims be interpreted as covering all such alterations and modification as fall within the true spirit and scope of the invention.

FIG. 1 shows a system embodying the present invention. The system comprises a main receiver unit 100 and a tunable filter 150. An external antenna 160 is coupled to the tunable filter 150 and the main receive unit 100 to receive radio frequency signals. The main receiver unit 100 includes an antenna interface 172 coupled to the antenna 160 to receive radio frequency signals. A low noise amplifier (LNA) 102 is used to amplify the signal received from the antenna 160 which is usually a very small signal. While the LNA 102 in FIG. 1 is shown as part of the main receive unit 100, the LNA 102 may be an external device (off chip) in some implementation. The tunable filter 150 receives control signals 124 from the tuning control circuitry 112 for tuning adjustment to achieve best receiving. The tuned and amplified radio frequency signal is then supplied to the mixer 104 to mix with a local oscillator signal 106. The LO generates a pair of signals having the same frequency at difference phases: one is called in-phase signal and the other is called quadrature signal. While a single mixer 104 is shown in FIG. 1, it is understood that the mixer is for complex signal consisting of a real part signal and an imaginary part signal. Alternatively, two separate scalar mixers can be drawn in FIG. 1. The mixer output signal 107 is the frequency translated signal corresponding to a desired signal having a frequency typically being the difference between the frequency of a desired radio frequency signal and the frequency of the LO signal. The mixed signal 107 is also a complex signal having a real part signal and an imaginary part signal. The mixed signal 107 is then converted into digital signals by a pair of analog-to-digital converters (ADC) 108a and 108b. Also, a single ADC may be drawn in some systems and it is understood that the ADC is for a complex signal and consists of two individual ADCs.

Upon the analog to digital conversion, the digitized signals can be conveniently processed by digital signal processing (DSP) circuitry 110. The digital signal processing circuitry 110 may be implemented in digital logics, field programmable gate array (FPGA), digital signal processor, or a combination of digital logics and microcontroller. In a normal receiving operation, the digital signal processing circuitry 110 will perform necessary receiving function to receive the intended signal. For example, in an FM audio receiver, the DSP circuitry 110 will perform digital filtering, FM demodulation, de-emphasis, and stereo de-multiplexing to produce a pair of stereo audio signals. FIG. 1 also shows a pair of digital-to-analog converters and audio buffers, 104a and 104b, which are used to provide amplified analog audio outputs. Usually the DSP circuitry 110 is designed to provide some additional information, characteristics, or measurement related to the underlying signal. These information, characteristics, or measurement can be used to provide system control or user interface. For example, the DSP circuitry 110 may be designed to measure received signal strength indicator (RSSI) which may be used in part to identify valid channels. The RSSI is a very popular measurement in the field of RF signals. The RSSI measurement usually adds up squared values of digitized data over a period of time. This measurement is related to the signal energy and is a good measurement on signal strength. There are also other formulas to compute the RSSI and can be used in the present invention.

The tunable filter 150 may be implemented on the same integrated circuit as the main receiver unit 100, either completely or partially. When the tunable filter 150 is completely on the same integrated circuit as the main receiver unit 100, the connection point 176 becomes the antenna interface for the integrated circuit and the connection points 172 and 174 are not needed. However, the required inductor 152 may be very challenging for cost effective implementation based on complementary metal-oxide-semiconductor (CMOS) technology. Therefore, the inductor 152 can be an external discrete component while the tunable capacitor circuitry 154 is implemented on chip. In this case, the connection point 174 becomes the antenna interface for the integrated circuit and the connection points 172 and 176 are not needed. There is also a situation that the complete tunable filter 150 is off chip. In this case, the connection point 172 becomes the antenna interface for the integrated circuit and the connection points 176 and 174 are not needed. The current invention can be applied to all cases of the tunable filter implementation regardless whether it is on chip, partially on chip, or off chip.

The tuning control circuitry 112 is responsible for providing the tuning control signal 124 to the tunable filter 150. The tuning control signals may also be simply called control signals for convenience. The tuning control circuitry 112 is coupled to the DSP circuitry 110 to receive signal parameters 122 derived by the DSP circuitry 110. The tuning control circuitry 112 may have to rely on previous signal parameters received from the DSP circuitry 110 and possibly previous tuning control signals 124 to make the best adjustment to the tunable filter 150. Therefore, the tuning control circuitry 112 requires some storage space to hold the signal parameters and control signals for a certain period of time. The storage space may be in a form of register, buffer, or flash memory. The tuning control circuitry 112 may provide the needed storage space of its own. Alternatively, the tuning control circuitry 112 may share storage space already existing on chip. For example, the DSP circuitry 110 may have some storage space allocated that can be shared with the tuning control circuitry 112. Based on the profile of the signal parameters 122 received from the DSP circuitry 110 and possibly previous tuning control signals 124, the tuning control circuitry 112 will determine the next tuning control signals that will adjust the tunable filter 150 to obtain the best receiving setting. The best receiving setting may be evidenced as a strongest RSSI or other similar measurement. Due to the time-varying nature of the received radio frequency signals, the tuning control circuitry 112 has to be designed to take into account the time-varying nature of the received radio frequency signals.

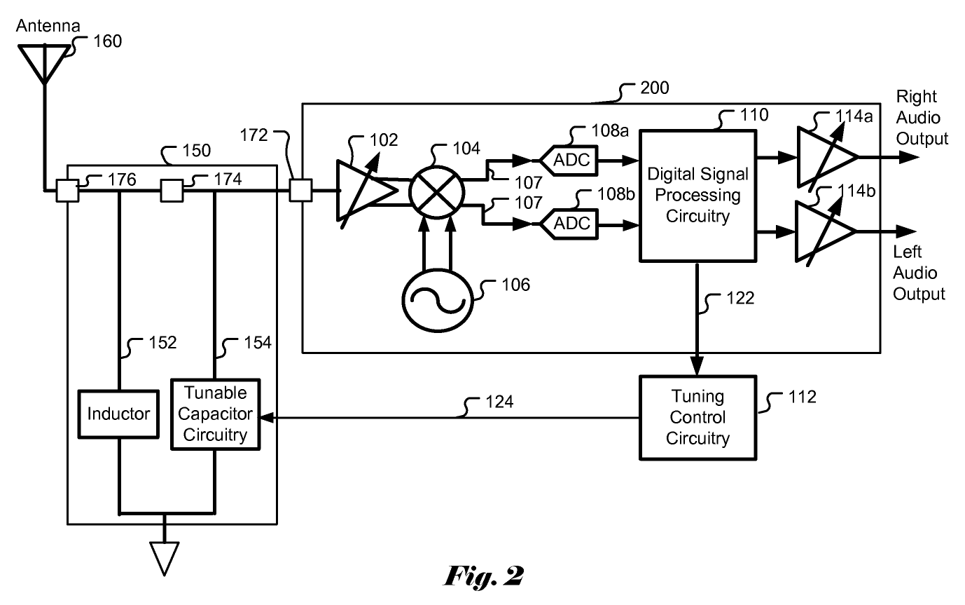

The operations required by the tuning control circuitry 112 may include some mathematical computations as well as logic decisions such as testing for condition to terminate a loop. The circuitry can be implemented using another DSP circuitry or can be implemented on the same DSP circuitry 110 of the main receiver unit 100. Also the tuning control circuitry 112 may be implemented by Finite State Machine (FSM) circuitry or by a microcontroller. The tuning control circuitry 112 can be implemented as either on-chip or off-chip. When an external microcontroller is used to implement the tuning control circuitry 112, the circuitry becomes off chip. FIG. 2 illustrates the arrangement of a radio frequency receiver having the tuning control circuitry 112 outside the main receiver unit 200. Other parts of the system are substantially the same as those of the system shown in FIG. 1.

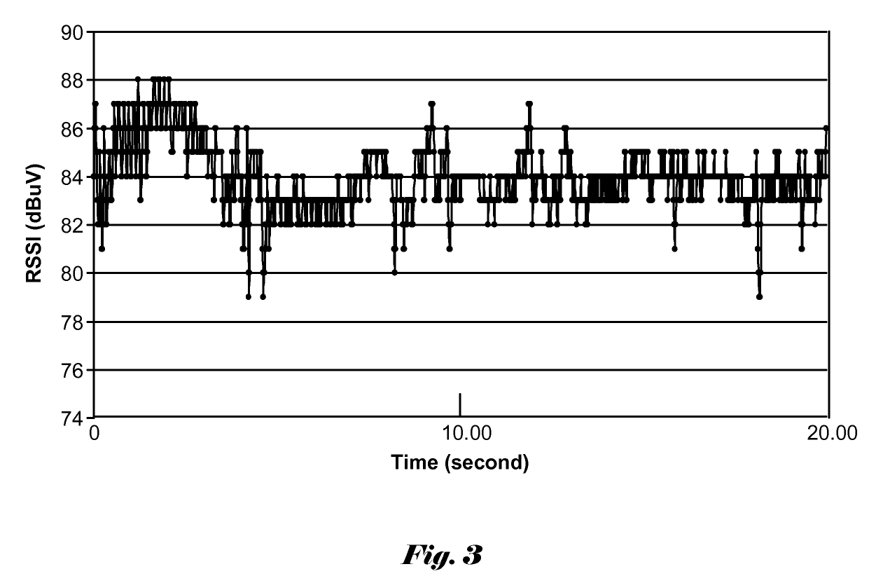

The multi-channel radio frequency signal received at the antenna input usually shows very dynamic characteristics even if the receiving condition is maintained stable. FIG. 3 shows a plot of RSSI recorded for an FM station received by an FM receiver with a fixed antenna at a fixed location. The tunable filter is tuned according to the nominal impedance of the fixed antenna at the specific receiving frequency. Over the period of 20 seconds measuring time, the RSSI shows a ±5 dB fluctuation. The RSSI is measured at 100 ms (millisecond) interval. Most of the times, two neighboring measured RSSI values show some local stability and the differences are 2 dB or less. On the other hand, the frequency response of the tunable filter has a much larger roll-off. The frequency response at the center of a tunable filter may be more than 10 dB higher than the frequency response at the edge corresponding to channel cut-off point. Therefore, even though the received radio signal is fluctuating, the trend of signal changes due to the adjustment of the tunable filter can be noticeably observed. Accordingly, the radio frequency signal may be utilized to help adjust the tunable filter to achieve a best performance.

In a mobile environment, such as a pedestrian walking or a jogger running with a portable device having an FM receiver, the received radio frequency signal may fluctuate faster and with a bigger swing. Nevertheless, the present invention still produces better performance compared with a system that does not practice the present invention. The signal parameters used to derive control signals for the tunable filter are measured over a time interval which may average out certain local fluctuations if the time interval is properly chosen. The temporal characteristics of the received radio frequency signal can be used to guide a proper time interval for the system operation of the present invention.

The tuning control circuitry 112 may also differentiate the case when a channel has just been changed from the case when a receiver continues to stay tuned to the same channel. When a channel is just switched, it may be desirable to quickly find a best adjustment for the tunable filter. On the other hand, when the receiver has tuned to a channel, the tuning control circuitry 112 may not have to adjust the tunable filter as quickly as for the channel switching case. When the receiver has tuned to a channel, the human body effect may affect the effective antenna impedance which is particularly true for portable devices. The human body may change the inductive and capacitive characteristics of the antenna of a portable device. The effect becomes more prominent when the portable device is held very close to the body. Therefore, the change in human body effect may off-tune the tunable filter which was properly tuned previously. A re-tune is needed periodically or when a noticeable change in measured signal parameters is detected. In the channel switching mode, the time interval for deriving the signal parameters and applying the new control signals can be shorter, such as 20 ms to 50 ms so that a best tuning may be achieved within a short period, such as half a second or so. Within a half second, up to 25 or 10 adjustments to the tunable filter can be done respectively if the time interval is at 20 ms or 50 ms. At the tuned mode, the time interval for deriving the signal parameters and applying the new control signals can be longer, such as 100 ms or longer. The 20 ms or 50 ms for the channel switching mode and 100 ms or longer for the tuned mode are for the purpose of illustration. The present invention is not bounded by these exemplary time intervals and is applicable to other time intervals as well.

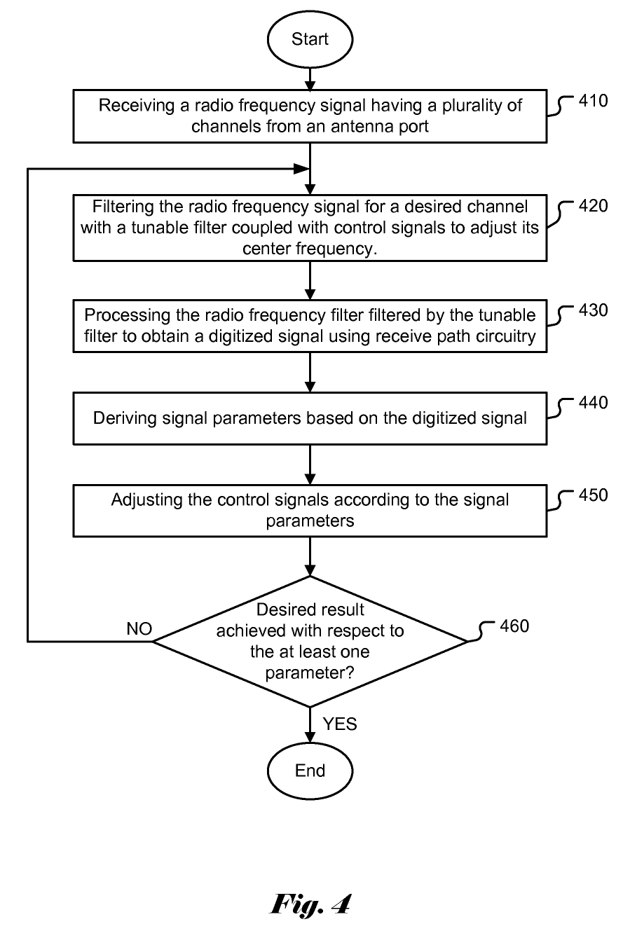

FIG. 4 illustrates a flow chart for steps of practicing the present invention in one embodiment. At step 410, a radio frequency signal having a plurality of channels is received from an antenna port. The received radio frequency signal is then filtered using a tunable filter to obtain a desired channel at step 420. The filtered radio frequency signal is then processed by the receive path circuitry to obtain a digitized signal at step 430. Some signal parameters are then derived based on the digitized signal at step 440. Based on the derived signal parameters, control signals are provided to the tunable filter to adjust the center frequency at step 450. After the new control signals are applied, the system checks if desired results are achieved with respect to the signal parameters at step 460. If the above condition is met, the tunable filter adjustment has reached the best tuning and the system enters the tuned mode. Otherwise, it goes back to the beginning of step 420 and repeats the steps again.

The control signals 124 can be generated based on many different methods. The key function for the tuning control circuitry is to provide control signals that will adjust the tunable filter toward the best performance. Due to the time-varying characteristics of the received radio frequency signals, the trend of the tunable filter performance has to be monitored instead of single-point performance. For example, the performance may have to be observed at a plurality of consecutive time intervals before the tuning control circuitry 112 determines the next control signals. The adjustment can be linear by adjusting the tunable filter at a fixed step size in one direction if the results are favorable (such as increasing RSSI) and reverses the direction and reduce the step size if the results become unfavorable (such as decreasing RSSI). Other search method may also be applied.

The above detailed description illustrates the specific embodiments of the present invention and is not intended to be limiting. Numerous modifications and variations within the scope of the invention are possible. The present invention is set forth in the following claims.

What is claimed is:

1. A method for automatic tuning a tunable filter of a portable radio frequency receiver, the method comprising:
receiving a radio frequency signal having a plurality of channels from an antenna port;
filtering the radio frequency signal for a desired channel using a tunable filter, wherein the tunable filter having a center frequency adjustable to cover a spectrum corresponding to the plurality of channels, and the tunable filter being coupled with at least one control signal for adjusting the center frequency;
processing the radio frequency signal filtered by the tunable filter to obtain a digitized signal using receive path circuitry;
deriving at least one signal parameter based on the digitized signal;
providing the at least one control signal to the tunable filter according to the at least one signal parameter; and
repeating the filtering, processing, deriving, and providing steps until a desired result is achieved with respect to the at least one signal parameter;
wherein the receiving, processing, deriving, and providing are at least in part performed in a single integrated circuit.

2. The method of claim 1, wherein the tunable filter comprises tunable capacitor circuitry coupled to an inductor in parallel to form an LC circuit;

3. The method of claim 2, wherein the tunable filter is at least in part on the single integrated circuit.

4. The method of claim 2, wherein the tunable capacitor circuitry comprises a plurality of parallel-connected capacitor circuits configured to be controlled by the at least one control signal.

5. The method of claim 1, wherein the at least one signal parameter includes a received signal strength indicator.

6. The method of claim 5, wherein the received signal strength indicator is related to summation of squared values of the digitized signal over a period of time.

7. The method of claim 5, wherein the received signal strength indicator is related to summation of absolute values of the digitized signal over a period of time.

8. The method of claim 1, wherein the radio frequency signal received at the antenna port includes an AM audio broadcast band, an FM audio broadcast band, a VHF terrestrial television broadcast band, or a UHF terrestrial television broadcast band.

9. The method of claim 1, wherein the repeating step is performed at a pre-specified time interval.

10. The method of claim 9, wherein the pre-specified time interval depends on states of the radio frequency receiver, wherein the states includes at least a channel switch state and a channel receive state.

11. A radio frequency receiver having a tunable filter comprising:
an antenna interface coupled to receive a radio frequency signal having a plurality of channels;
a tunable filter coupled to the antenna interface and configured to filter the radio frequency signal for a desired channel, wherein the tunable filter having a center frequency adjustable to cover a spectrum corresponding to the plurality of channels, and the tunable filter being coupled with at least one control signal for adjusting the center frequency;
receive path circuitry configured to receive and process the radio frequency signal filtered by the tunable filter to obtain a digitized signal and to derive at least one signal parameter based on the digitized signal; and
tuning control circuitry configured to receive the at least one signal parameter and coupled to the tunable filter to provide the at least one control signal;
wherein the antenna interface and the receive path circuitry are in a single integrated circuit.

12. The radio frequency receiver of claim 11, wherein the tunable filter comprises tunable capacitor circuitry coupled to an inductor in parallel to form an LC circuit;

13. The radio frequency receiver of claim 12, wherein the tunable filter is at least in part in the single integrated circuit.

14. The radio frequency receiver of claim 12, wherein the tunable capacitor circuitry comprises a plurality of parallel-connected capacitor circuits configured to be controlled by the at least one control signal.

15. The radio frequency receiver of claim 11, wherein the at least one signal parameter includes a received signal strength indicator.

16. The radio frequency receiver of claim 15, wherein the received signal strength indicator is related to summation of squared values of the digitized signal over a period of time.

17. The radio frequency receiver of claim 15, wherein the received signal strength indicator is related to summation of absolute values of the digitized signal over a period of time.

18. The radio frequency receiver of claim 11, wherein the receive path circuitry comprises:
a local oscillator to generate a desired local frequency;
a mixer coupled to receive the filtered radio frequency signal and the desired local frequency from the local oscillator to produce a mixed signal output;
an analog-to-digital converter to convert the mixed signal output into the digitized signal; and
digital signal processing circuitry configured to receive the digitized signal and to provide the at least one signal parameter.

19. The radio frequency receiver of claim 18, wherein the receive path circuitry further comprises a low noise amplifier coupled to receive and amplify the filtered radio frequency signal and coupled to the mixer to provided the amplified radio frequency signal.

20. The radio frequency receiver of claim 11, wherein the radio frequency signal received at the antenna interface includes an AM audio broadcast band, an FM audio broadcast band, a VHF terrestrial television broadcast band, or a UHF terrestrial television broadcast band.

21. The radio frequency receiver of claim 11, wherein the tuning control circuitry is in the single integrated circuit.

22. The radio frequency receiver of claim 11, wherein the tuning control circuitry is outside the single integrated circuit.
